(19) United States
(12) Patent Application Publication
(10) Pub. No.: US 2010/0195950 A1
(43) Pub. Date: Aug. 5, 2010

(54) Optical Sensor Fiber Having Zone Which is Sensitive to Bending, Sensor Having Such Sensor Fiber, and Method for Producing

(75) Inventors: Martin Franke, Berlin (DE); Tobias Happel, Berlin (DE); Herbert Schober, Barbing-Friesheim (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/308,422

(22) PCT Filed: Jun. 12, 2007
(86) PCT No.: PCT/EP2007/055773

§ 371 Date: Apr. 16, 2010

(30) Foreign Application Priority Data
Jun. 14, 2006 (DE) 10 2006 029 020.8

(51) Int. Cl. G02B 6/00

(52) U.S. Cl. 385/13

(57) ABSTRACT

An untreated fiber section in an optical sensor fiber has a zone which is framed by surface-treated fiber sections, thus making it possible to determine, by metrology, a mixture of light modes in the untreated fiber section that depends on bending. This advantageously makes it possible to measure the bending in the optical sensor fiber in a very accurate manner. The optical sensor fiber may be used in sensor having a laser diode and a photodiode.

### CROSS REFERENCE TO RELATED APPLICATIONS

This application is based on and hereby claims priority to International Application No. PCT/EP2007/055773, filed on Jun. 12, 2007, and German Application No. 10 2006 029 020.8, filed on Jun. 14, 2006, the contents of which are hereby incorporated by reference.

### BACKGROUND

Described below is an optical sensor fiber, having a zone which is sensitive to bending, which is equipped with surface-treated fiber sections which have increased optical damping compared to the untreated remainder of the sensor fiber. An optical sensor may be made with a sensor fiber of the type mentioned initially and in which a light source, in particular a light-emitting diode, is provided at one end of the sensor fiber for coupling measurement light into the sensor fiber, and in which a measurement transformer, in particular a photodiode for the measurement light which is coupled out of the sensor fiber, is arranged at the other end of the sensor fiber. Moreover, a method for producing a sensor fiber of the type mentioned initially will be described.

### Description of the Related Art

For example, a sensor fiber of the type mentioned initially, an optical sensor with such a sensor fiber, and a method for its production are described in CA 2 424 708 A1. This sensor fiber can, for example, be processed into a sensor band, in which a plurality of sensor fibers are arranged running in parallel in this band. The sensor fibers in the sensor band are provided with a light source and a measurement transformer in order, on the one hand, to be able to couple measurement light into the sensor fibers and, on the other hand, to be able to convert the coupled-out measurement light into an electric sensor signal, for example. In accordance with CA 2 424 708 A1, this process makes it possible to implement a bending sensor for the bumper of a motor vehicle for example, which detects the impact of a pedestrian by a specific de-formation pattern of the bending sensor and transmits the deformation pattern to a control device which initiates suitable measures to protect the pedestrian.

So as to generate specific deformation patterns, it is necessary for sections of the sensor fiber to be provided with a surface treatment which increases the damping properties of the sensor fibers in the regions as a function of the bend present. Such a surface treatment can include a mechanical treatment, in particular a roughening of the surface. By way of example, this is effected by sandblasting the surface or else by a heat embossing process, with the result that more of the light guided through the sensor fiber is lost in the region of the surface-treated fiber section—i.e. this causes stronger damping of the sensor fiber—than in untreated fiber sections in the case of a straight-running sensor fiber. The amount of the light lost in the surface-treated fiber section depends on the bend of the sensor fiber in that region. This creates a zone which is sensitive to bending, in which the damping decreases if the surface-treated fiber section is bent in a concave fashion, and in which the damping increases if the surface-treated fiber section is bent in a convex fashion. It is therefore possible to deduce the deformation state of the sensor fiber, and hence the optical sensor, by evaluating the amount of the measurement light coupled out at the end of the sensor fiber.

CA 2 424 708 A1 also considers possible embodiments of the zones which are sensitive to bending, with the goal of differentiating the deformations which characterize a pedestrian impact as unambiguously as possible from other deformation states of the sensor which is sensitive to bending, such as a frontal impact, by obtaining a defined sensor result. In the process, it was found that the measurement results are subject to a certain degree of fluctuation which is independent of the design of the zone which is sensitive to bending, and these fluctuations can in extreme cases compromise the unambiguousness of the measurement result.

In accordance with U.S. Pat. No. 5,633,494, it is proposed that a sensor band of the type specified above can be provided with a comparatively long zone which is sensitive to bending if it is divided into short sections which alternate with untreated sections. By these means, the sensitivity to bending of the treated sections is distributed over a greater length of the sensor fiber, a requirement for this being that the bending to be measured has a radius which is large enough for the respectively untreated sections to be bridged. In accordance with WO 00/68645, it is also possible to arrange a pair of sensor fibers in a sensor band which communicate optically with one another via their surface-treated sections such that a bending-dependent transmission of light from the one sensor fiber into the other sensor fiber is effected.

### SUMMARY

An aspect is to specify an optical sensor fiber, an optical sensor with such a sensor fiber and a method for producing such a sensor fiber, in which the sensor fiber is intended to deliver results which can be predicted comparatively well for a selected deformation case.

According to this aspect, the optical sensor fiber has an untreated fiber section which extends between two surface-treated fiber sections, with the sensor fiber being a multi-mode fiber. In other words, the untreated fiber sections between respectively two treated fiber sections form a zone which is sensitive to bending, i.e. not arranging the treated fiber sections in those regions in which a bend of the sensor fiber is intended to be evaluated, but in particular arranging the untreated fiber sections between the treated fiber sections. The treated fiber sections are arranged outside of the zone which is sensitive to bending. For the purposes of this disclosure, a zone which is sensitive to bending is understood to be that section of the optical sensor fiber which is intended to detect a change in the bend of the sensor fiber due to the present application. In the case of a bumper sensor for a motor vehicle, it is that region within the bumper which is intended to initiate a protective measure in the motor vehicle on impact with the legs of a pedestrian.

Considering the untreated fiber sections between the treated fiber sections, there was a surprising realization that the former regions likewise influence the sensor result depending on the bend present there. This can be traced back to the fact that the measurement light with higher modes (i.e. measurement light with steeper angles of reflection at the walls of the sensor fiber) is preferentially coupled out of the surface-treated fiber section in the surface-treated fiber sections, provided that measurement light having different modes is coupled in, and provided that the sensor fiber is a multi-mode fiber (which allows a plurality of modes of the measurement light to be guided through it). However, this also means that in the further course of the sensor fiber, after a surface-treated section, there is preferential transport of measurement light with lower modes.

If the surface-treated fiber sections are used as zones which are sensitive to bending, as described in CA 2 424 708 A1, with these zones being inserted repeatedly into the sensor fiber in constant sections over the length of the sensor fiber, a first measurement error occurs by virtue of the fact that once measurement light has been coupled out in a surface-treated fiber section, the higher light modes which are preferentially coupled out are no longer available over the further course of the sensor fiber, or are available only in reduced amounts. This means that in the case of an identical bend, less measurement light would be coupled out in following surface-treated fiber sections, so the resulting nonlinearity with regard to the measurement light coupled out in relation to the overall amount of bend of the sensor fiber would yield a falsification of the measurement result.

There is a further measurement error due to the occurrence of the so-called mode-mixing effect which depends on the bending in the untreated regions of the sensor fiber. This is understood to mean equalizing the proportion of the different light modes in the case of an uneven distribution of light modes in the measurement light, with this effect occurring more strongly with an increasing bend of the sensor fiber in untreated regions. However, this means that if light with higher modes is coupled out in a first surface-treated fiber section, the coupling out of measurement light in the following surface-treated fiber sections also depends on the bend of untreated fiber sections, because mode-mixing after higher modes have been coupled out leads to the fact that, depending on the bend, they are once again available in following surface-treated fiber sections.

This realization is used in an embodiment of the optical sensor fiber in that in particular the untreated fiber section is used as a zone which is sensitive to bending. That is to say the effect which yields a measurement error in an embodiment of the sensor fiber in accordance with the related art may be used for the targeted generation of the measurement result. This advantageously makes it possible to obtain measurement results which have a lower measurement inaccuracy and yield less ambiguous results with regard to evaluating a pedestrian impact when used as a bending sensor in the bumper of a motor vehicle, for example.

Another embodiment provides for the sensor fiber to have exactly two surface-treated fiber sections. The zone which is sensitive to bending then lies exactly between the two surface-treated fiber sections. In contrast to embodiments in accordance with the related art, in which the surface-treated fiber sections are used as the zone which is sensitive to bending, the zone which is sensitive to bending can be designed to have an almost arbitrary length in the case of an embodiment in which the only untreated fiber section lies between the treated fiber sections. This advantage is a result of the damping of the untreated fiber section being very low, that is to say the damping is of the order of that prescribed by the optical waveguide used for the sensor fiber. Specifically, only two surface-treated fiber sections are necessary, regardless of the length of the zone which is sensitive to bending; this is in contrast to sensor fibers in accordance with the related art, in which provision has to repeatedly be made for surface-treated fiber sections as zones which are sensitive to bending.

A particular embodiment is obtained if the surface-treated fiber sections are only provided in one half of the sensor fiber. Preferably, this is that half of the sensor fiber which forms the downstream half with regard to the direction of the transmission of the measurement light. The upstream half, up to the first surface-treated fiber section, can then be used to obtain the most extensive mode-mixing possible before coupling out the measurement light; as a result of this, measurement light coupled out in the first surface-treated fiber section can be predicted more accurately. This process makes it possible to further improve the accuracy of the measurement results.

An optical sensor can be equipped with the described fiber. In accordance with one embodiment of the sensor, provision is made for the sensor fiber which is untreated in the first half to be arranged running parallel to the second half. As it were, the middle of the sensor fiber is provided with a turning loop. As a result of this the sensor fiber can advantageously be arranged in a space-saving fashion, with it being possible for both the light source and the measurement transformer to be arranged in a housing into which the sensor fiber can be plugged with its two adjacent ends. It is also advantageous if the zone of the sensor fiber which is sensitive to bending is embedded in an elastic mounting body. The latter can firstly be used to protect the sensitive sensor fiber because it prevents damage to the surface of the sensor fiber which would lead to the falsification of measurement results. Furthermore, it is possible, by the elastic embedding of the sensor fiber, to equalize induced bending loads.

In a method for generating a sensor fiber like that described above, it is necessary to take into account the fact that the surface of the sensor fiber is treated taking into account the application to the extent that the surface-treated fiber sections lie at the ends of the zone to be generated which is sensitive to bending. In the process, the fiber sections can be integrated into the zone which is sensitive to bending, with the former then defining the respective ends of the zone which is sensitive to bending. On the other hand, it is possible that the surface-treated fiber sections are particularly advantageously also located outside of the zone which is sensitive to bending, as a result of which a particularly accurate measurement result can be obtained. The location of the zone which is sensitive to bending in the sensor band to be generated is prescribed by the application to the extent that the sensor band must be adapted to the geometry of the installation location.

In accordance with an advantageous refinement of the method, provision is made for the bending sensitivity of the sensor fiber to be adjusted by varying at least one of the following parameters: selection of fiber material, type of surface treatment, and geometry of the surface-treated fiber sections. The selection of the fiber material primarily influences the amount of mode-mixing that can be achieved in the sensitive zone as a function of bending. The type of surface treatment, for example laser ablation or heat embossing, primarily influences the mode-dependent coupling-out behavior of the surface-treated fiber sections. The geometry of the surface-treated fiber sections can be varied to mainly influence the bending dependence of the coupling out of measurement light. For example, if the surface of the fiber section is treated over the entire perimeter of the fiber, a bending dependence is eliminated to a great extent; as a result of this, the zone which is sensitive to bending cannot extend into the surface-treated fiber sections. If the surface is only treated on one side of the cross section of the sensor fiber, then this results in a strong bend dependence in the coupling out of measurement light.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block and line drawing that schematically shows the design of an exemplary embodiment of a sensor with a sensor fiber, with characteristic points a to f being marked on it,

FIG. 2 is a graph that shows possible damping profiles of the sensor fiber, with points a to f being marked, and

FIG. 3 is a perspective view of a sensor band, in which three exemplary embodiments of the sensor fiber are embedded.

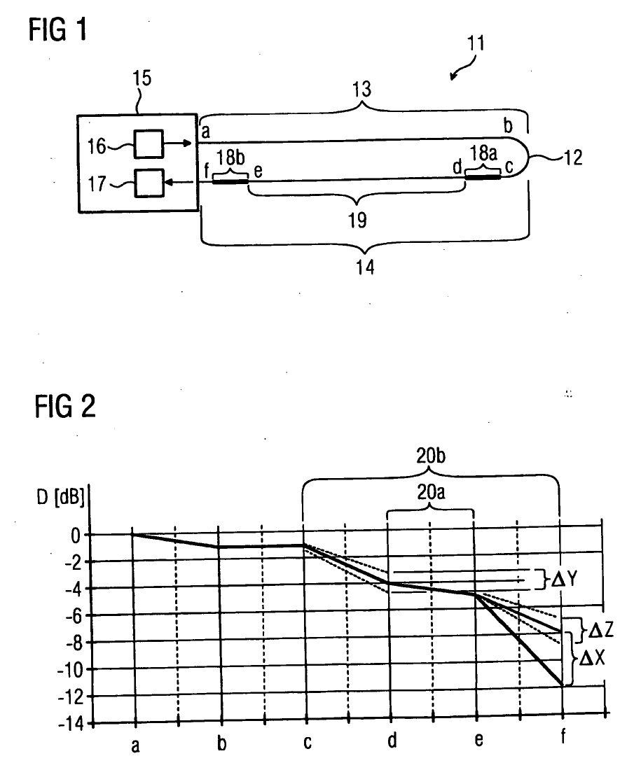

### DETAILED DESCRIPTION OF EXEMPLARY EMBODIMENTS

Reference will now be made in detail to exemplary embodiments which are illustrated in the accompanying drawings, wherein like reference numerals refer to like elements throughout.

A sensor 11 has a sensor fiber 12 which is laid out in a loop, with a first half 13 of the sensor fiber running parallel to a second half 14 of the sensor fiber. With its two ends, the sensor fiber is attached in a housing 15 for a laser diode 16, provided for coupling measurement light into the sensor fiber 11, and a photodiode 17, provided for coupling out the transmitted measurement light.

The measurement light traverses the first half of the sensor fiber 12 from a to b, with mode-mixing equalizing possible inhomogeneities in the measurement light which is coupled in by the laser diode. In the second half 14, higher modes of measurement light are preferentially coupled out in a first treated fiber section 18a (from c to d). Between d and e, the measurement light passes through an untreated fiber section 19, with only a small amount of mode-mixing occurring over the illustrated straight course of the sensor fiber. However, the stronger the bend in the untreated fiber section 19 is, the stronger the mode-mixing is as well; depending on the mode-mixing that occurred in the untreated fiber section 19, there is a stronger or weaker coupling out of measurement light in the second treated fiber section 18b (from e to f) because more higher modes which are preferentially coupled out are available again in the case of stronger mode-mixing.

FIG. 2 schematically illustrates the damping as it influences the measurement light in the sensor fiber 12, with the points a to f being plotted. In the first half 13, from a to b, a certain amount of light, which is substantially independent of the bend, is coupled out due to the length of the sensor band; this is likewise the case in the second half from b to e, since it is shorter only by an insubstantial amount. The damping is negligibly small in the turning region b to c of the sensor fiber 12 because this region is very short compared to the length of the sensor fiber, and because the bending radius is selected such that a loss-free transmission of the light is made possible in this region of the sensor fiber 12. The damping is most pronounced in the two treated fiber sections 18a, 18b, with the amount of light coupled out in the treated fiber section 18d strongly depending on the bending-dependent mode-mixing in the untreated region 19. This results in a range of measured values ΔX, which make it possible to deduce the bending present in the untreated fiber section 19 as a function of the effective damping in the treated fiber section 18b. Hence, ΔX represents the measurement value range which can be evaluated if the untreated fiber section 19 is used as a zone 20a which is sensitive to bending.

If the treated fiber sections 18a, 18b are designed such that the damping depends on the bending, and if these were to lie in a larger zone 20b which is sensitive to bending and which runs from c to f, a variation of the measurement results, corresponding to the dashed line plotted between c and d, and e and f, in FIG. 2, would have to be taken into account as a measurement error. The measurement result is thus falsified by the values ΔY and ΔZ.

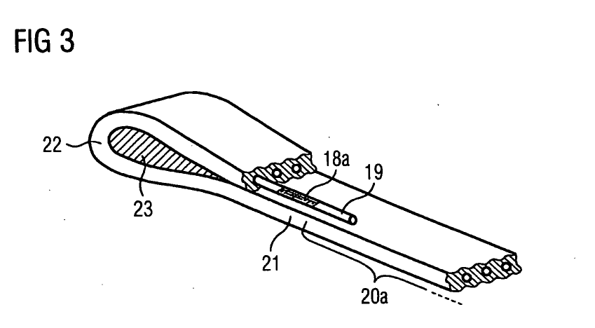

FIG. 3 illustrates a possible concrete design of the sensor fiber 12. Three sensor fibers 12 are embedded in an elastic sensor band as a mounting body 21. By way of example, the sensor band can include a rubber-elastic plastic. In order to generate a turning loop 22 with a diameter large enough for a low-loss transmission of the measurement light in the sensor fibers 12, an insert 23 defining the radius of the turning loop is provided in the turning loop.

One of the sensor fibers 12 is illustrated in part without the cladding of the mounting body 21. It is possible to see the surface treatment in the surface-treated fiber section 18a. It simultaneously defines the start of the untreated fiber section 19 and hence the position of the zone 20a which is sensitive to bending. The further fibers 12 can have treated fiber sections which are arranged in an offset fashion (not illustrated), so that evaluation of all sensor fibers makes spatial resolution in the sensor band 21 possible.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to exemplary embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A multi-mode optical sensor fiber, comprising:
surface-treated fiber sections; and
an untreated remainder, the surface-treated fiber sections having increased optical damping compared to the untreated remainder, the untreated remainder including an untreated fiber section forming a zone sensitive to bending which extends between two of the surface-treated fiber sections which are outside of the zone which is sensitive to bending.

10. The multi-mode optical sensor fiber as claimed in claim 9, wherein there are exactly two surface-treated fiber sections.

11. The multi-mode optical sensor fiber as claimed in claim 9, wherein the surface-treated fiber sections are only provided in one half of the sensor fiber.

12. An optical sensor, comprising:
a multi-mode optical sensor fiber having first and second ends, surface-treated fiber sections and an untreated remainder, the surface-treated fiber sections having increased optical damping compared to the untreated remainder, the untreated remainder including an untreated fiber section forming a zone sensitive to bending which extends between two of the surface-treated fiber sections which are outside of the zone which is sensitive to bending;
a laser diode at the first end of the multi-mode optical sensor fiber, outputting measurement light into the multi-mode optical sensor fiber; and
a photodiode at the other end of the multi-mode optical sensor fiber, receiving the measurement light from the multi-mode optical sensor fiber.

13. The optical sensor as claimed in claim 12, wherein the sensor fiber has two halves that abut and run parallel to one another.

14. The sensor as claimed in claim 13, further comprising an elastic mounting body in which the zone which is sensitive to bending is embedded.

15. A method for generating a multi-mode optical sensor fiber, comprising:
treating portions of a surface of the multi-mode optical sensor fiber to form surface-treated fiber sections, having increased optical damping compared to an untreated remainder of the multi-mode optical sensor fiber, at ends and outside of a bending-sensitive zone of the untreated remainder.

16. The method as claimed in claim 15, wherein bending sensitivity of the sensor fiber is adjusted by varying at least one of the following parameters: selection of fiber material, type of surface treatment and geometry of the surface-treated fiber sections.
